(19) United States
(12) Patent Application Publication
(10) Pub. No.: US 2026/0163280 A1
(43) Pub. Date: Jun. 11, 2026

(54) Female Connection Device, Battery System, Electric Battery Pack and Electric Battery-Related Device

(71) Applicant: Andreas Stihl AG &Co. KG, Waiblingen (DE)

(72) Inventors: Tobias WUERSCHUM, Remseck (DE); Lukas Hauser, Weinstadt (DE); Daniel Sauerteig, Kernen im Remstal (DE)

(21) Appl. No.: 19/178,969

(22) Filed: Apr. 15, 2025

(30) Foreign Application Priority Data
Apr. 16, 2024 (DE) 10 2024 110 612.3

(51) Int. Cl. H01R 13/11

(52) U.S. Cl. CPC H01R 13/113

(57) ABSTRACT

A female connection device for receiving a male connection device includes: an outer contact body which has an outer back region and two outer contact tongue regions that protrude opposite one another from the outer back region, wherein the outer contact tongue regions are designed to make electrical contact with the male connection device at a distance from the outer back region, wherein the outer back region and the outer contact tongue regions together form an outer body portion of the outer contact body, and an inner contact body which has an inner back region and two inner contact tongue regions that protrude opposite one another from the inner back region, wherein the inner contact tongue regions are designed to make electrical contact with the male connection device at a distance from the inner back region, wherein the inner back region. The inner contact tongue regions together form an inner body portion of the inner contact body. The outer body portion and the inner body portion are arranged in a nested manner such that they are not in contact with one another or such that they are only in contact with one another at the inner back region and at the outer back region.

### CROSS REFERENCE TO RELATED APPLICATION

This application claims priority under 35 U.S.C. § 119 from German Patent Application No. 10 2024 110612.3, filed Apr. 16, 2024, the entire disclosure of which is herein expressly incorporated by reference.

### BACKGROUND AND SUMMARY

The invention relates to a female connection device for an electric battery system and to such a battery system. The invention also relates to an electric battery pack for such an electric battery system and to an electric battery-related device for such an electric battery system.

The present invention addresses the problem of creating a female connection device for an electric battery system, such a battery system, an electric battery pack for such an electric battery system and an electric battery-related device for such an electric battery system, which each have improved properties. In particular, a current carrying capacity for an electrical contact between the female connection device and a complementary male connection device is intended to be increased, in particular by reducing an electrical contact resistance. In particular, as an alternative or in addition, a thermal budget in an electric contact system comprising the female connection device and the male connection device is intended to be improved.

This problem is solved by the subject matter of the independent claims. Preferred embodiments are the subject of the dependent claims.

A female connection device according to the invention can be used in an electric battery system. The female connection device for the electric battery system is designed to releasably receive a male connection device of the battery system in an electrically connecting manner. The male connection device may be referred to synonymously as a contact blade. The female connection device may form a connection socket.

The female connection device has a receiving direction in which the male connection device is able to be releasably received while being electrically connected to the female connection device. The received male connection device may be removed from the female connection device, in particular only, counter to the receiving direction.

The female connection device has an outer contact body. The outer contact body has an outer back region and two outer contact tongue regions. The two outer contact tongue regions are arranged opposite one another, in particular perpendicularly to the receiving direction. The two outer contact tongue regions protrude opposite one another from the outer back region. In this case, the outer contact tongue regions are designed to make electrical contact with the received male connection device at a distance from the outer back region. When the male connection device has been received by means of the female connection device, the outer contact tongue regions can thus contact the male connection device, in particular only, at a distance from the outer back region. The outer back region and the two outer contact tongue regions together form an outer body portion of the outer contact body.

The female connection device also has an inner contact body. The inner contact body has an inner back region and two inner contact tongue regions. The two inner contact tongue regions are arranged opposite one another, in particular perpendicularly to the receiving direction. The two inner contact tongue regions protrude opposite one another from the inner back region. In particular, the outer contact tongue regions protrude from the outer back region counter to the receiving direction. In particular, the inner contact tongue regions protrude from the inner back region counter to the receiving direction. The inner contact tongue regions are designed to make electrical contact with the received male connection device at a distance from the inner back region. When the male connection device has been received by means of the female connection device, the inner contact tongue regions can thus contact the male connection device, in particular only, at a distance from the inner back region. The inner back region and the two inner contact tongue regions together form an inner body portion of the inner contact body. The outer body portion of the outer contact body and the inner body portion of the inner contact body are arranged in a nested manner. In this case, the outer body portion and the inner body portion are arranged in a nested manner, either such that they are in contact with one another only at the inner back region and at the outer back region, or such that they are not in contact with one another. In any case, in particular, the body portions do not touch away from the back regions.

Advantageously, by means of the invention, a particularly large number of electrical contact points between the female connection device and the received male connection device can be achieved, this favouring a current carrying capacity of the releasable electrical connection between the female connection device and the male connection device received thereby. In addition, the provision of two contact bodies can favour a thermal budget in the female connection device, in particular in a contact system, comprising the female connection device and the male connection device, of the battery system.

Expediently, the outer body portion and/or the inner body portion each have a C-and/or U-shaped cross section. Alternatively or additionally, the outer body portion and/or the inner body portion may be formed in a channel-and/or trough-like manner.

Expediently, the two inner contact tongue regions are arranged between the outer contact tongue regions perpendicularly to the back longitudinal extension direction and perpendicularly to the receiving direction.

Expediently, the outer body portion may surround the inner body portion.

Expediently, the inner contact body and/or the outer contact body comprises a contact body material or consists of such a contact body material. The contact body material may be a copper alloy. The copper alloy may comprise at least 99% by mass Cu. For example, the copper alloy may be CuSn6 or CuCrAgFeTiSi. Alternatively or additionally, the contact body material may be provided with a coating. The coating may comprise tin or consist of tin. The coating may comprise tin silver or consist of tin silver.

In one refinement of the invention, one of the inner contact tongue regions together with one of the outer contact tongue regions, in particular a closest and/or adjacent one, defines a respective gap of the female connection device. The gap is in particular empty. In particular, each gap measures 0.05 mm to 0.4 mm, for example 0.3 mm, perpendicularly to the receiving direction, in particular at least in a gap portion of the gap that extends parallel to the receiving direction. In particular, the gap is not designed to receive the male connection device. Advantageously, as a result of the gap, an at least largely mutually independent elastic spring behaviour of the inner and the outer contact tongue regions can be achieved.

In a further refinement of the invention, a thickness of the outer contact body and a thickness of the inner contact body are identical or different in terms of size. The thickness of the outer contact body may be 0.5 mm to 0.7 mm. In particular, the thickness of the outer contact body corresponds, in terms of size, to 1 to 1.5 times the thickness of the inner contact body. Alternatively or additionally, in particular to specify the thickness ratio of the contact bodies, the outer contact tongue regions project beyond the inner contact tongue regions counter to the receiving direction, in particular away from the outer back region and the inner back region.

The thickness of the outer contact body and the thickness of the inner contact body may in particular be measured perpendicularly to a contact area between the contact bodies. A thickness of the inner contact body may be measured in the direct continuation of the thickness of the outer contact body. In particular, the thicknesses of the contact bodies are measured parallel to the receiving direction away from the contact body portions and/or in the back regions. The outer contact body and/or the inner contact body may be produced from a sheet-metal material, wherein the respective thickness corresponds to a sheet thickness of the sheet-metal material.

In a further refinement of the invention, the inner contact body has at least one connecting region that transitions into the inner back region, in particular perpendicularly to the receiving direction. The inner contact body may have two connecting regions, between which the inner back region is arranged, in particular perpendicularly to the receiving direction. The outer contact body has at least one connecting region which transitions into the outer back region, in particular perpendicularly to the receiving direction. The outer contact body may have two connecting regions, between which the outer back region is arranged, in particular perpendicularly to the receiving direction. The inner contact body and the outer contact body are connected together, in particular only, at their connecting regions. In particular, the inner contact body and the outer contact body are connected together in a materially bonded and/or form-fitting manner at their connecting regions. In the respective connecting region, there may be at least one local connecting zone for the materially bonded and/or form-fitting connection. By means of the materially bonded and/or form-fitting connection of the connecting regions of the contact bodies, the contact bodies can be fastened together. In particular, a material bond, in particular as a result of a welded connection, between the contact bodies is formed only in the connecting zone in question. Alternatively or additionally, the contact bodies may be connected together, in particular only, at their connecting regions in a form-fitting manner, in particular by means of clinching.

Expediently, the back regions of the body portions extend along a common back longitudinal extension direction, in particular perpendicular to the receiving direction. There may be respective connecting portions on both sides of the body portions along the back longitudinal extension direction. In particular, the connecting portions of the outer body portion and the connecting portions of the inner body portion are formed and/or arranged in a complementary manner to one another. Alternatively or additionally, it is conceivable for the outer contact body to be in the form of a first contact body-part portion of a materially cohesive contact body part and for the inner contact body to be in the form of a second contact body-part portion of the same contact body part, wherein the second contact body-part portion is folded down onto the first contact body-part portion. A bending fold that results from such folding down may in this case be arranged in a connecting region away from the back regions.

In a further refinement of the invention, at least one, in particular each, of the inner contact tongue regions is at least partially slotted at least once along the receiving direction such that at least two spring finger portions of the inner contact tongue region in question are formed, said spring finger portions extending, in particular at least substantially, parallel to one another and being individually elastically deflectable. There may thus be a slot of the inner contact tongue region in question between two spring finger portions. It goes without saying that a plurality of slots may be provided, such that a plurality of spring finger portions, arranged in a row perpendicularly to the receiving direction, of the inner contact tongue region are formed. Alternatively or additionally, at least one, in particular each, of the outer contact tongue regions is at least partially slotted at least once along the receiving direction such that at least two spring finger portions of the outer contact tongue region in question are formed, said spring finger portions extending, in particular at least substantially, parallel to one another and being individually elastically deflectable. There may thus be a slot of the outer contact tongue region in question between two contact tongue portions that are adjacent perpendicularly to the receiving direction. It goes without saying that a plurality of slots may be provided for each outer contact tongue region, such that a plurality of spring finger portions, arranged in a row perpendicularly to the receiving direction, of the outer contact tongue region are formed. The at least partially slotted contact tongue regions with spring finger portions may be formed in a fork-like manner, in particular in the manner of a dinner fork, wherein the spring finger portions are formed in the manner of fork tines.

“At least partially slotted” may refer to the fact that the contact tongue regions are not slotted fully in the receiving direction as far as the respective back region of the associated contact body. Each contact tongue region may thus have a slot-free portion between the associated back region and its spring finger portions.

Expediently, the spring finger portions are formed in a lamellar manner.

Expediently, the spring finger portions of the outer contact body and of the inner contact body may be arranged in a mutually aligned manner perpendicularly to the receiving direction and perpendicularly to the back longitudinal extension direction of the female connection device. Alternatively, it may be expedient for the spring finger portions of the outer contact body to be arranged in an offset manner with regard to the back longitudinal extension direction, in particular in a staggered manner, with respect to the spring finger portions of the inner contact body.

Expediently, there are three spring finger portions per contact tongue region, i.e. the contact tongue region in question is at least partially slotted twice. It goes without saying that some other number of spring finger portions may also be expedient per contact tongue region. In particular, it is conceivable for the inner contact tongue regions to have the same number of spring finger portions as or a different number of spring finger portions from the outer contact tongue regions.

In a further refinement of the invention, at least one, in particular each, spring finger portion of at least one, in particular of each, inner contact tongue region has a free contact end for making electrical contact with the received male connection device. Alternatively or additionally, at least one, in particular each, spring finger portion of at least one, in particular of each, outer contact tongue region has a free contact end for making electrical contact with the received male connection device. The free contact end of the respective finger portion has a contact face that is curved, in particular in the form of a lens segment, for making electrical contact, in particular tangential and/or point contact, with the received male connection device. Advantageously, by means of such curved contact faces, the electrical contacting of the received male connection device can be defined particularly precisely, in particular with regard to position and/or extension. Under certain circumstances, such curved contact faces may be particularly robust and/or reduce insertion forces when the male connection device is received by means of the female connection device.

Expediently, the female connection device may have a contact grease which is applied at least to the contact faces. The contact grease may reduce insertion forces and/or have an oxidation-reducing effect.

In a further refinement of the invention, the inner back region and the outer back region jointly extend in an elongate manner along the back longitudinal extension direction of the female connection device, wherein the back longitudinal extension direction extends perpendicularly to the receiving direction. The inner back region has at least one corrugation extending perpendicularly to the back longitudinal extension direction and perpendicularly to the receiving direction. Alternatively or additionally, the outer back region has at least one corrugation extending perpendicularly to the back longitudinal extension direction and perpendicularly to the receiving direction. By means of such a corrugation, a stiffness of the back region in question can be improved, in particular with regard to bending loads, about a virtual bending axis extending parallel to the back longitudinal extension direction.

In a further refinement of the invention, the outer body portion has at least one corrugation which extends from one of the outer contact tongue regions via the outer back region to the other of the outer contact tongue regions, in particular along a substantially C- and/or U-shaped directrix. In particular, the corrugation of the outer body portion extends from one of the outer contact tongue regions via the outer back region to the other of the outer contact tongue regions and into a spring finger portion of the respective outer contact tongue region. Alternatively or additionally, at least one, in particular each, of the inner contact tongue regions has no corrugation.

Under certain circumstances, however, it is contemplated for the inner body portion also to have at least one corrugation, which extends from one of the inner contact tongue regions via the inner back region to the other of the inner contact tongue regions, in particular into a spring finger portion of the respective inner contact tongue region.

A battery system according to the invention has an electric battery pack, in particular an electric rechargeable-battery pack, for storing electrical energy. In addition, the battery system has an electric battery-related device which is releasably electrically connectable to the battery pack. In this case, the battery pack and the battery-related device have complementary connection devices, of which at least one is in the form of a female connection device according to any of the preceding claims and at least one other is in the form of a male connection device. The advantages of the female connection device that are set out above can thus be transferred to the battery system according to the invention.

An electric battery pack according to the invention for an electric battery system, in particular an electric battery system according to the invention, has at least one female connection device according to the invention, as described above. In this regard, the advantages of the female connection device according to the invention can also be transferred to the electric battery pack according to the invention, having such a female connection device. The battery pack has in particular a plurality of electric battery cells for storing electrical energy.

An electric battery-related device for an electric battery system, in particular an electric battery system according to the invention, has at least one female connection device according to the invention, as described above. In this regard, the above-described advantages of the female connection device according to the invention can also be transferred to the electric battery-related device according to the invention, having such a female connection device. The electric battery-related device may be an electric power tool, in particular a handheld electric power tool. The electric power tool may have an electric motor that is driven by means of electrical energy from an electric battery pack. By means of the electric motor, a tool device that is connected or able to be connected to the electric power tool can be driven in order to machine a workpiece. Alternatively or additionally, the electric battery-related device may be a battery charger for charging an electric battery pack with electrical energy. It is conceivable for a combined battery-related device to have both the battery charger and the electric power tool.

Further advantages and features of the invention will become apparent from the claims and from the following description of a preferred exemplary embodiment of the invention, which is illustrated by way of the drawing. In this case, the same reference signs refer to the same or similar or functionally identical components.

It goes without saying that the features that are mentioned above and those that will be explained below are usable not only in the respectively specified combination, but also in other combinations or on their own, without departing from the scope of the present invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic perspective illustration of an embodiment of a female connection device according to the invention;

FIG. 2 is a schematic front view of the female connection device according to FIG. 1;

FIG. 3 is a schematic sectional illustration of the female connection device according to FIGS. 1 and 2;

FIG. 4 is a schematic perspective illustration of an embodiment of an electric battery pack according to the invention; and

FIG. 5 shows an embodiment of an electric battery-related device according to the invention.

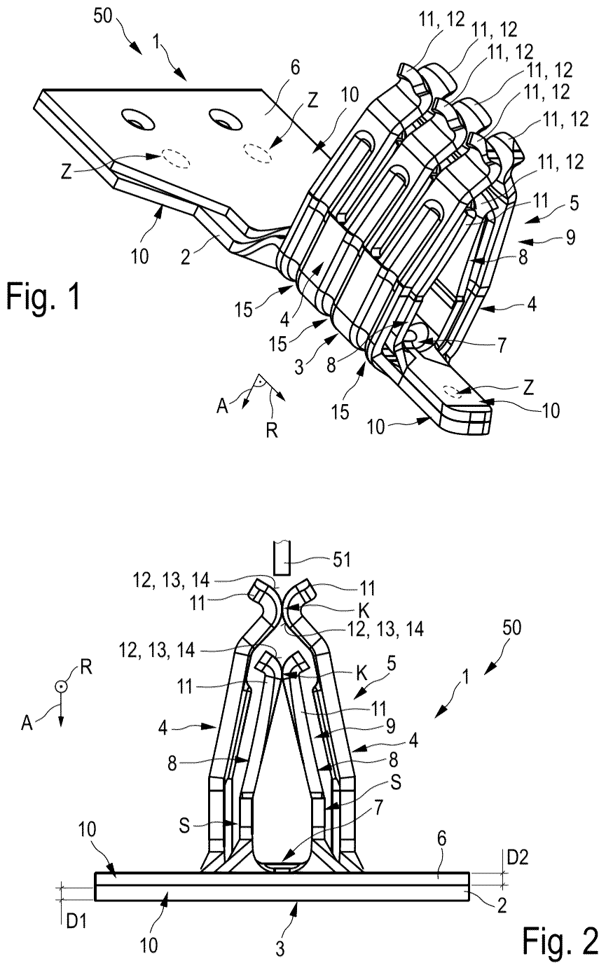

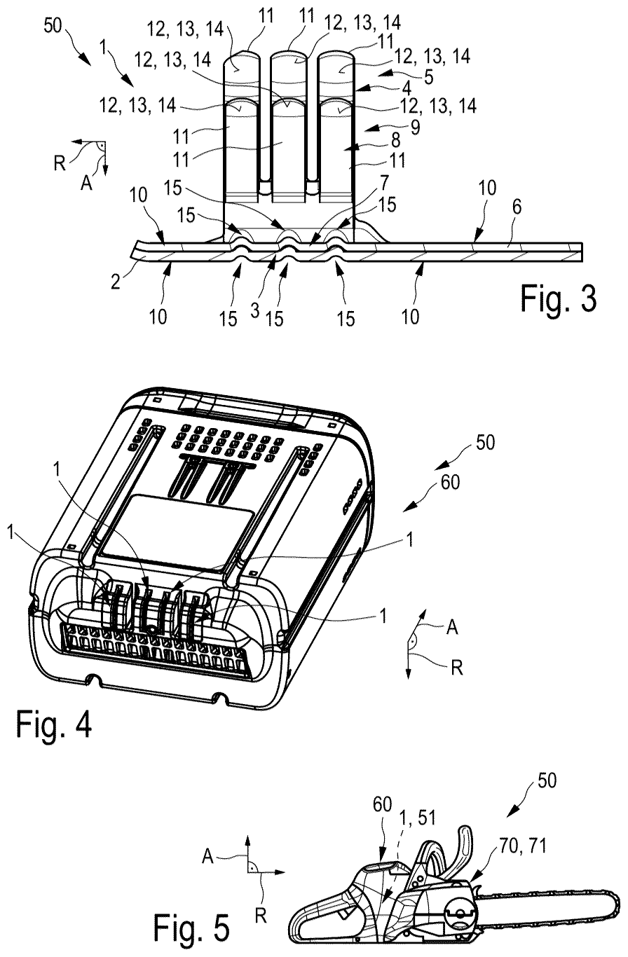

### DETAILED DESCRIPTION OF THE DRAWINGS

A female connection device 1 is provided for an electric battery system 50. In the present case, the female connection device 1 is used in the electric battery system 50. The female connection device 1 is in this case designed to receive a male connection device 51 of the battery system 50 in a receiving direction A of the female connection device 1. Concomitant with the receiving of the male connection device 51, the female connection device 51 is releasably electrically connected to the male connection device 51. When the male connection device 51 has been received by means of the female connection device 1, a releasable electrical connection between the female connection device 1 and the male connection device 51 is created. The male connection device 51 is in the present case not able to be received by the female connection device 1 without the male connection device 51 and the female connection device 1 being electrically connected together.

The battery system 50 has an electric battery pack 60 for storing electrical energy. In addition, the battery system 50 has an electric battery-related device 70, which is releasably electrically connected to the battery pack 60. The battery pack 60 and the battery-related device 70 have complementary electric connection devices 1, 51. Of the complementary connection devices 1, 51 of the battery pack 60 and of the battery-related device 70, at least one is in the form of a female connection device 1 and at least one other is in the form of a male connection device 51. Either the battery pack 60 or the battery-related device 70 thus have at least one female connection device 1, whereas the respective other of the battery pack 60 and the battery-related device 70 has at least one male connection device 51.

In the present case, the electric battery pack 60 has at least one female connection device 1. Alternatively or additionally, the electric battery-related device 70 has at least one female connection device 1. The electric battery-related device may be in the form of an electric power tool 71 and/or of a battery charger. In the example in FIG. 5, the electric battery-related device 70 is in the form of a motorized chain saw as an electric power tool 71.

The female connection device 1 has an outer contact body 2 and an inner contact body 6.

The outer contact body 2 has an outer back region 3 and two outer contact tongue regions 4. The outer contact tongue regions 4 protrude opposite one another from the outer back region 3. In the present case, the outer contact tongue regions 4 both protrude from the outer back region 3 counter to the receiving direction A. The outer contact tongue regions 4 are designed to make electrical contact with the received male connection device 51 at a distance from the outer back region 3. In particular, the received male connection device 51 makes contact with the outer contact body 2 only at a distance from the outer back region 3 at the outer contact tongue regions 4. The outer back region 3 and the two outer contact tongue regions 4 together form an outer body portion 5 of the outer contact body 2.

The inner contact body 6 has an inner back region 7 and two inner contact tongue regions 8 that protrude opposite one another from the inner back region 7. In the present case, the inner contact tongue regions 8 both protrude from the inner back region 7 counted to the receiving direction A. The inner contact tongue regions 8 are designed to make electrical contact with the received male connection device 51 at a distance from the inner back region 7. In particular, the received male connection device 51 makes contact with the inner contact body 6 only at a distance from the inner back region 7 at the inner contact tongue regions 8. The inner back region 7 and the two inner contact tongue regions 8 together form an inner body portion 9 of the inner contact body 6.

The outer body portion 5 and the inner body portion 9 are arranged in a nested manner. In the present case, the outer body portion 5 and the inner body portion 9 are arranged in a nested manner such that the body portions 5, 9 are in contact with one another only at the inner back region 7 and at the outer back region 3.

As an alternative to the embodiment shown, it is possible for the outer body portion 5 and the inner body portion 9 to be arranged in a nested manner such that they do not touch one another. There may thus be a distance between the body portions 5, 9, in particular between their back regions 3, 7. There can then only be an electrical connection between the outer contact body 2 and the inner contact body 6 away from the body portions 5, 9.

The inner contact body 6 and the outer contact body 2 may comprise a contact body material or consist of such a contact body material. The contact body material is a copper alloy in the present case. The copper allow may comprise at least 99% by mass Cu. For example, the copper alloy may be CuSn6. Alternatively or additionally, the contact body material may be provided with a coating. The coating may comprise tin or consist of tin. The coating may comprise tin silver or consist of tin silver.

In the present case, one of the inner contact tongue regions 8 defines, together with one of the outer contact tongue regions 4, a respective gap S of the female connection device 1. In the present case, there are two such gaps S, which externally flank the inner body portion 9 and which are in turn themselves flanked externally by the outer contact tongue regions 4 of the outer contact body 2. In the present case, each gap S measures 0.05 mm to 0.4 mm, for example 0.3 mm, perpendicularly to the receiving direction A, for example at least in a gap portion of the respective gap S that extends parallel to the receiving direction A.

The respective gap S is, in the present case, not designed to receive the male connection device 51. In the received state, the male connection device 51 projects, in the present case, into an intermediate space between the inner contact tongue regions 8 such that the received male connection device 51 is engaged by means of the inner body portion 9, wherein the inner body portion 9 engaging the male connection device 51 is in turn engaged, together with the engaged male connection device 51, by the outer body portion 5. In the present case, the intermediate space is different from the gaps S.

In the present case, the outer contact body 2 has a thickness D1. The inner contact body 6 has, for example, a thickness D2. The thicknesses D1, D2 of the inner contact body 6 and of the outer contact body 2 may, in terms of size, be the same or—as in the present case—different. The thickness D1 of the outer contact body 2 may be, for example, 0.5 mm to 0.7 mm. The thickness D1 of the outer contact body 2 may correspond to 1 to 1.5 times the thickness D2 of the inner contact body 6.

In the present case, the outer contact tongue regions 4 project beyond the inner contact tongue regions 8 counter to the receiving direction A. In this case, the outer contact tongue regions 4—in the present case remote from the outer back region 3 and the inner back region 7—protrude beyond the inner contact tongue regions 8 counter to the receiving direction A. As measured along the receiving direction A, the outer contact tongue regions 4 may extend correspondingly longer than the inner contact tongue regions 8.

The thickness D1 of the outer contact body 2 is measured, in the present case, perpendicularly to a contact plane between the contact bodies 2, 6. The thickness D2 of the inner contact body 6 is measured, for example, in the direct continuation of the thickness D1 of the outer contact body 2. In particular, the thickness D1 of the outer contact body 2 and/or the thickness D2 of the inner contact body 6 corresponds to a sheet thickness of a sheet-metal material from which the contact body 2, 6 in question is produced, in particular by forming.

The inner contact body 6 has, for example, at least one connecting region 10 that transitions into the inner back region 7. The outer contact body 2 has, for example, at least one connecting region 10 that transitions into the outer back region 3. In the connecting regions 10, the inner contact body 6 and/or the outer contact body 2 may have substantially a sheet thickness that corresponds to the respective thickness D1, D2 of the contact body 2, 6 in question. In particular, the connecting regions 10 extend substantially in a flat and/or planar manner, for example perpendicularly to the receiving direction A.

The inner contact body 6 and the outer contact body 2 are connected together, in particular fastened together, for example at their connecting regions 10. In the present case, the inner contact body 6 and the outer contact body 2 are connected together only at the connecting regions 10 that are in contact with one another, in particular in order to fasten the inner contact body 6 and the outer contact body 2 together away from the body portions 5, 9. The contact bodies 2, 6 may be connected together in a form-fitting and/or materially bonded manner at their connecting regions 10. In the present case, the two contact bodies 2, 6 are connected together in a materially bonded manner at their connecting regions 10.

There may be at least one local connecting zone Z for the materially bonded connection in the respective connecting region 10. In the present case, a material bond, for example as a result of a welded connection, between the contact bodies 2, 6 is formed only in the connecting zone Z in question. Alternatively or additionally, the contact bodies 2, 6 may be connected together in a form-fitting manner, in particular by means of clinching, for example only, at their connecting regions 10.

In the present case, there are connecting portions 10 on both sides of the body portions 5, 9 along a back longitudinal extension direction R of the female connection device 1. Each contact body 2, 6 thus has, in the present case, two connecting regions 10, between which the body portion 5, 9 of the contact body 2, 6 in question is arranged. Alternatively or additionally, it is conceivable for the outer contact body 2 to be in the form of a first contact body-part portion of a materially cohesive contact body part and for the inner contact body 6 to be in the form of a second contact body-part portion of the same contact body part, wherein the second contact body-part portion is folded down onto the first contact body-part portion. A bending fold that results from such folding down may in this case be arranged in a connecting region 10 away from the back regions 3, 7. The contact body part may be a single materially uniform sheet-metal part.

For example, at least one, in the present case each, of the inner contact tongue regions 8 is at least partially—in the present case only partially—slotted at least once along the receiving direction A such that at least two spring finger portions 11 of the inner contact tongue region 8 in question are formed. The spring finger portions 11 of the inner contact tongue region 8 extend, for example, substantially parallel to one another. The spring finger portions 11 of the inner contact tongue region 8 are individually elastically deflectable in the present case.

Alternatively or additionally, for example at least one, in the present case each, of the outer contact tongue regions 4 is at least partially—in the present case only partially—slotted at least once along the receiving direction A such that at least two spring finger portions 11 of the outer contact tongue region 4 in question are formed. The spring finger portions 11 of the outer contact tongue region 4 in question extend, for example, substantially parallel to one another. The spring finger portions 11 of the outer contact tongue region 4 in question are individually elastically deflectable.

The spring finger portions 11 of the outer contact body 2 and the spring finger portions 11 of the inner contact body 6 may, as in the present case, be arranged in a mutually aligned manner perpendicularly to the receiving direction A and perpendicularly to the back longitudinal extension direction R of the female connection device 1. Alternatively, it is conceivable for the spring finger portions 11 of the outer contact body 2 to be arranged in an offset manner with regard to the back longitudinal extension direction R, in particular in a staggered manner, with respect to the spring finger portions 11 of the inner contact body 6.

In the present case, there are three spring finger portions 11 per contact tongue region 4, 8, i.e. the contact tongue region 4, 8 in question is, in the present case only, partially slotted at least twice. The contact tongue regions 4, 8 each have, in the present case, a non-slotted portion which connects the respective spring finger portions 11 to the associated back regions 3, 7 along the receiving direction A. The respective non-slotted portion may extend substantially parallel to the receiving direction A.

The spring finger portions 11 may extend at an angle to the receiving direction A. Spring finger portions 11 of the outer contact body 2 that are opposite one another perpendicularly to the receiving direction A and perpendicularly to the back longitudinal extension direction R extend towards one another counter to the receiving direction A in the present case, in particular in pairs. Spring finger portions 11 of the inner contact body 6 that are opposite one another perpendicularly to the receiving direction A and perpendicularly to the back longitudinal extension direction R extend towards one another counter to the receiving direction A in the present case, in particular in pairs.

In the present case, each spring finger portion 11 has a free contact end 12 for making electrical contact with the received male connection device 51. In this case, spring finger portions 11 of the outer contact body 2 that are opposite one another perpendicularly to the receiving direction A and perpendicularly to the back longitudinal extension direction R may touch one another when the male connection device 51 is not received, cf., for example, FIG. 2.

The free contact ends 12 of spring finger portions 11 of the inner contact body 6 that are opposite one another perpendicularly to the receiving direction A and perpendicularly to the back longitudinal extension direction R may touch one another, in particular in pairs, when the male connection device 51 is not received.

When the male connection device 51 is not received, the outer body portion 5 may fully engage the inner body portion 9 as seen along the back longitudinal extension direction R.

The body portions 5, 9 may be formed and/or arranged in a mirror-symmetric manner, in particular with regard to a plane of symmetry of the female connection device 1 that is defined along the receiving direction A and the back longitudinal extension direction R.

The free contact end 12 of each spring finger portion 11 has, for example, a curved contact face 13, which is designed to make electrical contact, for example point contact, with the received male connection device 51.

The spring finger portions 11 may be formed in a lamellar manner and/or in the manner of fork tines.

The female connection device 1 may have a contact grease 14 which is applied at least to the contact faces 13. The contact grease 14 may have an oxidation-reducing effect for the contact body material of the respective contact body 2, 6. In addition, the contact grease 14 may have a friction-reducing effect in order to reduce insertion forces when the male connection device 51 is received by means of the female connection device 1.

In the present case, the inner back region 7 and the outer back region 3 jointly extend in an elongate manner along the back longitudinal extension direction R. The back longitudinal extension direction R extends perpendicularly to the receiving direction A. The inner back region 7 has, for example, at least one corrugation 15 extending perpendicularly to the back longitudinal extension direction R and perpendicularly to the receiving direction A. Alternatively or additionally, the outer back region 3—as in the present case—may have at least one corrugation 15 extending perpendicularly to the back longitudinal extension direction R and perpendicularly to the receiving direction A.

In the present case, the outer body portion 5 has at least one corrugation 15, which extends from one of the outer contact tongue regions 4 via the outer back region 3 to the other of the outer contact tongue regions 4. In the present case, the corrugation 15 of the outer body portion 5 extends in each case into a spring finger portion 11 of the respective outer contact tongue region 4.

By way of example, at least one, in the present case each, of the inner contact tongue regions 8 has no corrugation. In alternative embodiments that are not shown, the inner body portion 9 may have at least one corrugation 15, which extends from one of the inner contact tongue regions 8 via the inner back region 7 to the other of the inner contact tongue regions 8, in particular into a spring finger portion 11 of the respective inner contact tongue region 8.

Each corrugation 15 that projects into a spring finger portion 11 may end at a distance from the free contact end 12 of the spring finger portion 11 in question along the receiving direction A.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A female connection device for an electric battery system, wherein the female connection device is designed to releasably receive a male connection device of the battery system in an electrically connecting manner in a receiving direction of the female connection device, the female connection device comprising:
an outer contact body which has an outer back region and two outer contact tongue regions that protrude opposite one another from the outer back region, wherein the two outer contact tongue regions are configured to make electrical contact with the received male connection device at a distance from the outer back region, wherein the outer back region and the two outer contact tongue regions together form an outer body portion of the outer contact body; and
an inner contact body which has an inner back region and two inner contact tongue regions that protrude opposite one another from the inner back region, wherein the two inner contact tongue regions are configured to make electrical contact with the received male connection device at a distance from the inner back region, wherein the inner back region and the two inner contact tongue regions together form an inner body portion of the inner contact body,
wherein the outer body portion and the inner body portion are arranged in a nested manner so as not to be in contact with one another or so as to only be in contact with one another at the inner back region and at the outer back region.

2. The female connection device according to claim 1, wherein
one of the two inner contact tongue regions together with one of the two outer contact tongue regions defines a respective gap(S) of the female connection device.

3. The female connection device according to claim 2, wherein
the gap measures 0.05 mm to 0.4 mm perpendicularly to the receiving direction at least in a gap portion of the gap that extends parallel to the receiving direction.

4. The female connection device according to claim 1, wherein
a thickness (D1) of the outer contact body and a thickness (D2) of the inner contact body are identical or different in terms of size, and/or
the two outer contact tongue regions project beyond the two inner contact tongue regions counter to the receiving direction away from the outer back region and the inner back region.

5. The female connection device according to claim 4, wherein
the thickness (D1) of the outer contact body corresponds, in terms of size, to 1 to 1.5 times the thickness (D2) of the inner contact body.

6. The female connection device according to claim 1, wherein
the inner contact body has at least one connecting region that transitions into the inner back region,
the outer contact body has at least one connecting region that transitions into the outer back region, and
the inner contact body and the outer contact body are connected together only at their connecting regions in a form-fitting and/or materially bonded manner.

7. The female connection device according to claim 1, wherein
at least one of the two inner contact tongue regions is at least partially slotted at least once along the receiving direction to form at least two spring finger portions of the respective inner contact tongue region, said two spring finger portions extending parallel to one another and being individually elastically deflectable, and/or
at least one of the two outer contact tongue regions is at least partially slotted at least once along the receiving direction to form at least two spring finger portions of the respective outer contact tongue region, said two spring finger portions extending parallel to one another and being individually elastically deflectable.

8. The female connection device according to claim 7, wherein
at least one spring finger portion of at least one inner contact tongue region and/or at least one spring finger portion of at least one outer contact tongue region has a free contact end for making electrical contact with the received male connection device, and
the free contact end has a contact face that is curved for making electrical contact with the received male connection device.

9. The female connection device according to claim 8, wherein
the electrical contact is a point contact with the received male connection device.

10. The female connection device according to claim 1, wherein
the inner back region and the outer back region jointly extend in an elongate manner along a back longitudinal extension direction of the female connection device, wherein the back longitudinal extension direction extends perpendicularly to the receiving direction,
the inner back region and/or the outer back region has/have at least one corrugation extending perpendicularly to the back longitudinal extension direction and perpendicularly to the receiving direction.

11. The female connection device according to claim 1, wherein
the outer body portion has at least one corrugation which extends from one of the outer contact tongue regions via the outer back region to the other of the outer contact tongue regions, and/or
wherein at least one of the inner contact tongue regions has no corrugation.

12. The female connection device according to claim 11, wherein
the outer body portion has at least one corrugation which extends from one of the outer contact tongue regions via the outer back region into a spring finger portion of the respective outer contact tongue region.

13. A battery system, comprising:
an electric battery pack for storing electrical energy; and
an electric battery-related device which is releasably electrically connectable to the electric battery pack,
wherein the battery pack and the battery-related device have complementary connection devices, of which at least one is in the form of a female connection device according to claim 1, and at least one other is in the form of the male connection device.

14. An electric battery pack for an electric battery system, wherein the electric battery pack comprises at least one female connection device according to claim 1.

15. An electric battery-related device for an electric battery system wherein the electric battery-related device has at least one female connection device according to claim 1.
